(19) United States
(12) Patent Application Publication
(10) Pub. No.: US 2026/0351470 A1
(43) Pub. Date: Nov. 5, 2026

(54) CIRCUIT BOARD, TRANSFORMER, MICROWAVE GENERATING APPARATUS AND HOUSEHOLD APPLIANCE

(71) Applicant: GUANGDONG MIDEA KITCHEN APPLIANCES MANUFACTURING CO., LTD., Foshan (CN)

(72) Inventors: Yan Cheng, Foshan (CN); Qinghai Li, Foshan (CN); Xiaoping Xu, Foshan (CN); Fei Chen, Foshan (CN); Fubao Wang, Foshan (CN); Wei Gao, Foshan (CN); Xinghua Liu, Foshan (CN); Yutaka Takashige, Foshan (CN)

(21) Appl. No.: 19/484,846

(22) PCT Filed: Nov. 22, 2023
(86) PCT No.: PCT/CN2023/133345

§ 371 Date: Dec. 26, 2025

(30) Foreign Application Priority Data
May 16, 2023 (CN) 202310555916.2
May 16, 2023 (CN) 202321190233.3
May 16, 2023 (CN) 202321190303.5

(51) Int. Cl. H01F 27/32; H01F 27/26; H01F 30/10; H01F 38/00; H01F 38/14; H05B 6/66

(52) U.S. Cl. CPC H01F 27/325; H01F 27/263; H01F 30/10; H01F 38/14; H05B 6/662; H01F 2038/003

(57) ABSTRACT

Provided are a circuit board, a transformer (20), a microwave generating apparatus, and a household appliance. The circuit board is applied in the microwave generating apparatus. The circuit board includes a substrate, a transformer, and a voltage-doubling rectifier capacitor. The transformer is disposed on the substrate. The voltage-doubling rectifier capacitor is disposed between the substrate and the transformer. The voltage-doubling rectifier capacitor is disposed below the transformer to reduce a space of the circuit board occupied by the voltage-doubling rectifier capacitor. The voltage-doubling rectifier capacitor is disposed below the transformer to confine a movement of the voltage-doubling rectifier capacitor.

### CROSS-REFERENCE TO RELATED APPLICATIONS

This application claims priority to Chinese Patent Application No. 202321190303.5, filed on May 16, 2023, No. 202310555916.2, filed on May 16, 2023, and No. 202321190233.3, filed on May 16, 2023, the entire disclosure of which are incorporated herein by reference.

### FIELD

The present disclosure relates to the technical field of circuit boards, and in particular, to a circuit board, a transformer, a microwave generating apparatus, and a household appliance.

### BACKGROUND

In the related art, a microwave oven is provided with an electric control board that includes a substrate, a transformer, and a voltage-doubling rectifier capacitor. The voltage-doubling rectifier capacitor and the transformer are arranged side by side on the substrate, resulting in an excessively large volume of the electric control board.

### SUMMARY

Embodiments of the present disclosure provide a circuit board, a transformer, a microwave generating apparatus, and a household appliance.

A circuit board according to the embodiments of the present disclosure is applied in a microwave generating apparatus. The circuit board includes a substrate, a transformer disposed on the substrate, and a voltage-doubling rectifier capacitor disposed between the substrate and the transformer.

In the circuit board according to the above embodiments of the present disclosure, the voltage-doubling rectifier capacitor is disposed below the transformer to reduce a space of the circuit board occupied by the voltage-doubling rectifier capacitor. In this way, a volume of the circuit board can be reduced, which is beneficial to miniaturization of the circuit board. In addition, the voltage-doubling rectifier capacitor is disposed below the transformer to confine a movement of the voltage-doubling rectifier capacitor. In this way, the voltage-doubling rectifier capacitor is prevented from floating during its soldering, which would otherwise result in a cold solder joint.

In some embodiments, the transformer includes a bobbin sheet. The voltage-doubling rectifier capacitor is disposed between the bobbin sheet and the substrate.

In some embodiments, the transformer includes a first baffle disposed at an end of the bobbin sheet. The first baffle is configured to confine a partial movement space of the voltage-doubling rectifier capacitor in a horizontal direction of the circuit board.

In some embodiments, the transformer has pin holders. The circuit board further includes a discharge resistor disposed between the pin holders. The pin holders are configured to restrain the discharge resistor.

In some embodiments, the circuit board includes a bus capacitor and a differential mode inductor. The bus capacitor is disposed between the differential mode inductor and the transformer, and the differential mode inductor and the bus capacitor are sequentially arranged on the substrate.

In some embodiments, the circuit board includes a heat sink disposed away from a center of the circuit board, and a resonant capacitor disposed between a part of the heat sink and the substrate. The heat sink is configured to reduce a temperature of the resonant capacitor.

In some embodiments, the circuit board includes a power device detachably connected to a side surface of the heat sink.

In some embodiments, the heat sink includes a plurality of heat sink fins configured to increase a contact area with air.

In some embodiments, the circuit board includes at least two voltage-doubling rectifier capacitors symmetrically arranged in a length direction of the circuit board.

In some embodiments, the transformer includes: a magnetic core structure including two magnetic cores, in which each of the two magnetic cores has a first magnetic column of a flat shape, and a length direction of the first magnetic column is along a length direction of the magnetic core; a bobbin having an insertion hole that fits a shape of the first magnetic column, in which a hole wall of the insertion hole has a first groove and a second groove that are formed on an outer side of the hole wall and spaced apart from each other, the first magnetic column is at least partially located in the insertion hole, and two first magnetic columns are spaced apart from each other and arranged opposite to each other; a first coil wound around the outer side of the hole wall of the insertion hole and located in the first groove; and a second coil wound around the outer side of the hole wall of the insertion hole and located in the second groove.

In some embodiments, a ratio of a length L of the first magnetic column to a width d of the first magnetic column ranges from 2 to 40.

In some embodiments, the width d of the first magnetic column ranges from 5 mm to 12 mm.

In some embodiments, the transformer includes: a magnetic core structure including two magnetic cores, in which each of the two magnetic cores has a first magnetic column; a bobbin having an insertion hole that fits a shape of the first magnetic column, in which a hole wall of the insertion hole has a first groove and a second groove that are formed on an outer side of the hole wall and spaced apart from each other, the first magnetic column is at least partially located in the insertion hole, and two first magnetic columns of the two magnetic cores are spaced apart from each other and arranged opposite to each other, in which a bottom surface of the first groove serves as a first winding surface, a bottom surface of the second groove serves as a second winding surface, and a height difference exists between the first winding surface and the second winding surface in a radial direction of the insertion hole; a first coil wound on the first winding surface and located in the first groove; and a second coil wound on the second winding surface and located in the second groove.

In some embodiments, the height difference ranges from 0.5 mm to 4 mm.

A transformer according to the embodiments of the present disclosure includes: a magnetic core structure including two magnetic cores, in which each of the two magnetic cores has a first magnetic column of a flat shape, and a length direction of the first magnetic column is along a length direction of the magnetic core; a bobbin having an insertion hole that fits a shape of the first magnetic column, in which a hole wall of the insertion hole has a first groove and a second groove that are formed on an outer side of the hole wall and spaced apart from each other, the first magnetic column is at least partially located in the insertion hole, and two first magnetic columns of the two magnetic cores are spaced apart from each other and arranged opposite to each other; a first coil wound around the outer side of the hole wall of the insertion hole and located in the first groove; and a second coil wound around the outer side of the hole wall of the insertion hole and located in the second groove.

In the transformer according to the above embodiments of the present disclosure, the first magnetic column is of a flat shape, and the insertion hole fits the shape of the first magnetic column. Without increasing volumes of the transformer and the magnetic core and the cost of the transformer, an anti-saturation capability of the transformer can be enhanced, and a height and volume of the transformer can be further reduced, realizing miniaturization of the household appliance.

In some embodiments, the first coil is a primary coil, and the second coil is a secondary coil. Two first magnetic columns of the two magnetic cores are spaced apart from each other and arranged opposite to each other to form an air gap. The air gap is located adjacent to the first coil.

In some embodiments, a width of the air gap ranges from 1.5 mm to 3.2 mm.

In some embodiments, a bottom surface of the first groove serves as a first winding surface, and a bottom surface of the second groove serves as a second winding surface. A height difference exists between the first winding surface and the second winding surface in a radial direction of the insertion hole.

A transformer according to the embodiments of the present disclosure includes: a magnetic core structure including two magnetic cores, in which each of the two magnetic cores has a first magnetic column; a bobbin having an insertion hole that fits a shape of the first magnetic column, in which a hole wall of the insertion hole has a first groove and a second groove that are formed on an outer side of the hole wall and spaced apart from each other, the first magnetic column is at least partially located in the insertion hole, and two first magnetic columns of the two magnetic cores are spaced apart from each other and arranged opposite to each other, in which a bottom surface of the first groove serves as a first winding surface, a bottom surface of the second groove serves as a second winding surface, and a height difference exists between the first winding surface and the second winding surface in a radial direction of the insertion hole; a first coil wound on the first winding surface and located in the first groove; and a second coil wound on the second winding surface and located in the second groove.

In the above transformer, the first coil is wound on the first winding surface, and the second coil is wound on the second winding surface. The height difference exists between the first winding surface and the second winding surface in the radial direction of the insertion hole. As a result, the first coil and the second coil are wound in a staggered manner. In this way, a coupling coefficient can be reduced, and a hard switching characteristic of IGBT at low power can be reduced, thus enabling adaptation to low-power application.

In some embodiments, the height difference ranges from 0.5 mm to 4 mm.

In some embodiments, the height difference exists over a circumference of the insertion hole by 360°.

In some embodiments, the insertion hole is of a flat shape, and a length direction of a radial cross-section of the insertion hole is perpendicular to a height direction of the transformer. The height difference includes a first height difference in the length direction of the radial cross-section of the insertion hole and a second height difference in a width direction of the radial cross-section of the insertion hole. The first height difference is equal to the second height difference.

In some embodiments, the first magnetic column is of a flat shape that fits a shape of the insertion hole, and a length direction of the first magnetic column is along a length direction of the magnetic core.

In some embodiments, each of the two magnetic cores includes a connection portion and a second magnetic column. The first magnetic column and the second magnetic column are connected to each other by the connection portion. The second magnetic column is located outside the insertion hole, and two second magnetic columns are spaced apart from each other and arranged opposite to each other outside the first groove.

In some embodiments, in a height direction of the transformer, a distance between an upper edge of the first magnetic column and an upper edge of the connection portion is m, where m=(L/k−1)*d, in which k ranges from 5 to 20, L represents a length of the first magnetic column, and d represents a width of the first magnetic column.

In some embodiments, a ratio of a length L of the first magnetic column to a width d of the first magnetic column ranges from 2 to 40.

In some embodiments, the width d of the first magnetic column ranges from 5 mm to 12 mm.

In some embodiments, the bobbin includes a second baffle. The first groove is separated from the second groove by the second baffle, and a thickness g of the second baffle ranges from 3.5 mm to 5 mm.

A microwave generating apparatus according to the embodiments of the present disclosure includes the circuit board according to any one of the above embodiments or the transformer according to any one of the above embodiments.

In the microwave generating apparatus according to the above embodiments of the present disclosure, the voltage-doubling rectifier capacitor is disposed below the transformer to reduce the space of the circuit board occupied by the voltage-doubling rectifier capacitor. In this way, the volume of the circuit board can be reduced, which is beneficial to the miniaturization of the circuit board. In addition, the voltage-doubling rectifier capacitor is disposed below the transformer to confine the movement of the voltage-doubling rectifier capacitor. In this way, the voltage-doubling rectifier capacitor is prevented from floating during the soldering, which would otherwise result in the cold solder joint.

A household appliance according to the embodiments of the present disclosure includes the circuit board according to any one of the above embodiments or the transformer according to any one of the above embodiments.

In the household appliance according to the above embodiments of the present disclosure, the first magnetic column is of a flat shape, and the insertion hole fits the shape of the first magnetic column. Without increasing the volumes of the transformer and the magnetic core and the cost of the transformer, the anti-saturation capability of the transformer can be enhanced, and the height and the volume of the transformer can be further reduced, realizing the miniaturization of the household appliance. In addition, the first coil is wound on the first winding surface, and the second coil is wound on the second winding surface. The height difference exists between the first winding surface and the second winding surface in the radial direction of the insertion hole. As a result, the first coil and the second coil are wound in a staggered manner. In this way, the coupling coefficient can be reduced, and the hard switching characteristic of IGBT at low power can be reduced, thus enabling adaptation to low-power application.

Additional aspects and advantages of the present disclosure will be partially given in the following description, and partially will become obvious from the following description, or will be understood through practice of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a first structural schematic diagram of a circuit board according to an embodiment of the present disclosure;

FIG. 2 is a second structural schematic diagram of a circuit board according to an embodiment of the present disclosure;

FIG. 3 is a third structural schematic diagram of a circuit board according to an embodiment of the present disclosure;

FIG. 4 is a fourth structural schematic diagram of a circuit board according to an embodiment of the present disclosure;

FIG. 5 is a fifth structural schematic diagram of a circuit board according to an embodiment of the present disclosure;

FIG. 6 is a sixth structural schematic diagram of a circuit board according to an embodiment of the present disclosure;

FIG. 7 is a module schematic diagram of a microwave generating apparatus according to an embodiment of the present disclosure;

FIG. 8 is a structural schematic diagram of a transformer according to an embodiment of the present disclosure;

FIG. 9 is another structural schematic diagram of a transformer according to an embodiment of the present disclosure;

FIG. 10 is a structural schematic diagram of a magnetic core according to an embodiment of the present disclosure;

FIG. 11 is another structural schematic diagram of a magnetic core according to an embodiment of the present disclosure;

FIG. 12 is a structural schematic diagram of a magnetic core structure according to an embodiment of the present disclosure;

FIG. 13 is a structural schematic diagram of a bobbin according to an embodiment of the present disclosure;

FIG. 14a to FIG. 140 are structural schematic diagrams of different magnetic cores according to embodiments of the present disclosure;

FIG. 15 is a cross-sectional view of a transformer according to an embodiment of the present disclosure;

FIG. 16 is a structural schematic diagram of a magnetic core of a transformer in the related art; and FIG. 17 is a structural schematic diagram of a transformer in the related art.

### DESCRIPTION OF MAIN REFERENCE NUMERALS OF COMPONENTS

microwave generating apparatus—1000; circuit board—100; substrate—10; transformer—20; voltage—doubling rectifier capacitor—30; discharge resistor—40; bus capacitor—50; differential mode inductor—60; heat sink—70; screw—80; power device—90; bobbin sheet—21; primary winding—22; secondary winding—23; first baffle—24; pin holder—25; groove—26; heat sink fin—71; resonant capacitor—91; receiving space—92; magnetic core structure—210; bobbin—220; first coil—230; second coil—240; air gap—250; magnetic core—211; insertion hole—221; first groove—222; second groove—223; second baffle—224; first magnetic column—2111; connection portion—2112; second magnetic column—2113; first winding surface—2221; second winding surface—2231.

### DETAILED DESCRIPTION

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

In the description of the present disclosure, terms “first” and “second” are only used for descriptive purposes, and cannot be understood as indicating or implying relative importance or implicitly indicating the number of the indicated technical features. Therefore, the features associated with “first” and “second” may explicitly or implicitly include at least one of the features. In the description of the present disclosure, the term “plurality” means two or more, unless defined otherwise explicitly and specifically.

In the description of the present disclosure, it should be noted that, unless otherwise clearly specified and limited, terms such as “install”, “connect”, “connect to”, and the like should be understood in a broad sense. For example, it may be a fixed connection or a detachable connection or connection as one piece; mechanical connection or electrical connection; direct connection or indirect connection through an intermediate; internal communication of two components or the interaction relationship between two components. For those skilled in the art, the specific meaning of the above-mentioned terms in the present disclosure can be understood according to specific circumstances.

In the description of the present disclosure, the first feature “on” or “under” the second feature may mean that the first feature is in direct contact with the second feature, or the first and second features are in indirect contact through another feature between the first and second features. Moreover, the first feature “above” the second feature means that the first feature is directly above or obliquely above the second feature, or simply means that the level of the first feature is higher than that of the second feature. The first feature “below” the second feature may mean that the first feature is directly below or obliquely below the second feature, or simply mean that the level of the first feature is smaller than that of the second feature.

Various embodiments or examples for implementing different structures of the present disclosure are provided below. In order to simplify the description of the present disclosure, components and configurations of specific examples are described below. These specific examples are merely for the purpose of illustration, rather than limiting the present disclosure. Further, the same reference numerals and/or reference letters may appear in different examples of the present disclosure for the purpose of simplicity and clarity, instead of indicating a relationship between different embodiments and/or the discussed configurations. In addition, the present disclosure provides examples of various specific processes and materials. However, applications of other processes and/or the use of other materials are conceivable for those of ordinary skill in the art.

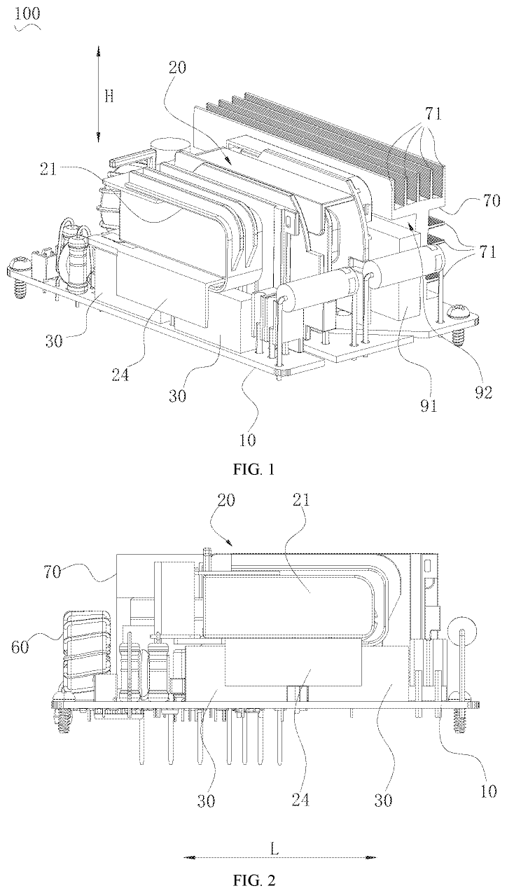

Referring to FIG. 1, a circuit board 100 according to the embodiments of the present disclosure is applied in a microwave generating apparatus 1000. The circuit board 100 includes a substrate 10, a transformer 20, and a voltage-doubling rectifier capacitor 30. The transformer 20 is disposed on the substrate 10. The voltage-doubling rectifier capacitor 30 is disposed between the substrate 10 and the transformer 20.

In the above circuit board 100, the voltage-doubling rectifier capacitor 30 is disposed below the transformer 20 to reduce a space of the circuit board 100 occupied by the voltage-doubling rectifier capacitor 30. In this way, a volume of the circuit board 100 can be reduced, which is beneficial to miniaturization of the circuit board 100. In addition, the voltage-doubling rectifier capacitor 30 is disposed below the transformer 20, which is configured to confine a movement of the voltage-doubling rectifier capacitor 30. In this way, the voltage-doubling rectifier capacitor 30 is prevented from floating during its soldering, which would otherwise result in a cold solder joint.

In an exemplary embodiment of the present disclosure, current variable-frequency microwave control mostly adopts a single-ended resonant converter and a high-voltage multiplier circuit. The single-ended resonant converter may adopt a variable-frequency topology structure. A single switching tube completes inversion while realizing soft switching control. In order to reduce a voltage that a secondary side of the variable-frequency transformer 20 needs to withstand, improve an obtainable voltage at a load side, and improve operation stability of the magnetron, variable-frequency microwaves mostly use a voltage-doubling rectifier circuit. The voltage-doubling rectifier circuit has a simple structure and is convenient to control. The voltage-doubling rectifier circuit is divided into a half-wave voltage-doubling rectifier circuit and a full-wave voltage-doubling rectifier circuit. Currently, the full-wave voltage-doubling rectifier circuit is mostly used. The full-wave voltage-doubling rectifier circuit may consist of two high-voltage diodes (not shown) and a high-voltage film capacitor (not shown).

In an embodiment shown in FIG. 1, the substrate 10 may be of a rectangular shape. The substrate 10 may support the transformer 20, and thus the transformer 20 may be connected to the substrate 10. As a main component on the circuit board 100, the transformer 20 may be disposed adjacent to a center of the substrate 10. The circuit board 100 is provided with a voltage-doubling rectifier capacitor 30 that may be disposed adjacent to an end of the transformer 20. The voltage-doubling rectifier capacitor 30 may be disposed between the substrate 10 and the transformer 20. By disposing the voltage-doubling rectifier capacitor 30 below the transformer 20, the space of the circuit board 100 occupied by the voltage-doubling rectifier capacitor 30 is reduced. In this way, the volume of the circuit board 100 can be reduced, which is beneficial to the miniaturization of the circuit board 100. In addition, the voltage-doubling rectifier capacitor 30 is disposed below the transformer 20 to confine the movement of the voltage-doubling rectifier capacitor 30. In this way, the voltage-doubling rectifier capacitor 30 is prevented from floating during the soldering, which would otherwise result in the cold solder joint.

Referring to FIG. 1 and FIG. 2, in some embodiments, the transformer 20 includes a bobbin sheet 21. The voltage-doubling rectifier capacitor 30 is disposed between the bobbin sheet 21 and the substrate 10.

In this way, it is possible to solve a problem that the voltage-doubling rectifier capacitor 30 is prevented from floating during the soldering, which would otherwise result in the cold solder joint.

In an exemplary embodiment of the present disclosure, in FIG. 1, the bobbin sheet 21 may be disposed above the voltage-doubling rectifier capacitor 30. The voltage-doubling rectifier capacitor 30 may be inserted into the substrate 10 and disposed between the bobbin sheet 21 and the substrate 10. A height direction of the circuit board 100 may be denoted by H. By disposing the voltage-doubling rectifier capacitor 30 between the bobbin sheet 21 and the substrate 10, a movement space of the voltage-doubling rectifier capacitor 30 in the H direction of the circuit board 100 can be confined. In this way, it is possible to solve the problem that the voltage-doubling rectifier capacitor 30 is prevented from floating during the soldering, which would otherwise result in the cold solder joint.

It should be noted that in an embodiment, the occurrence of the floating of the voltage-doubling rectifier capacitor 30 refers to a component that is not inserted in place during the insertion of the voltage-doubling rectifier capacitor 30, thus causing the soldered component to be skewed and raised. The cold solder joint refers to a solder joint with only a small amount of solder, resulting in poor contact.

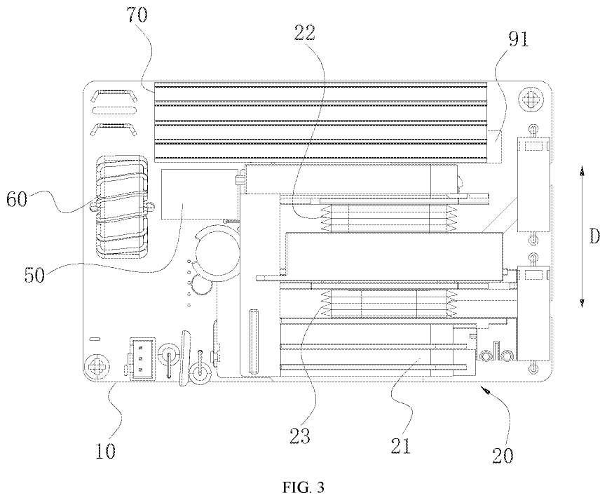

In addition, in an embodiment shown in FIG. 3, the transformer 20 further includes a primary winding 22 and a secondary winding 23. The secondary winding 23 may be wound around an end of the bobbin sheet 21 adjacent to the voltage-doubling rectifier capacitor 30. The primary winding 22 may be wound around another end of the bobbin sheet 21. The voltage-doubling rectifier capacitor 30 may be disposed between the secondary winding 23 and the substrate 10, which thus can further confine the movement space of the voltage-doubling rectifier capacitor 30.

Referring to FIG. 1 and FIG. 2, in some embodiments, the transformer 20 includes a first baffle 24 disposed at an end of the bobbin sheet 21. The first baffle 24 is configured to confine a partial movement space of the voltage-doubling rectifier capacitor 30 in a horizontal direction of the circuit board 100.

In this way, the partial movement space of the voltage-doubling rectifier capacitor 30 in the horizontal direction of the circuit board 100 can be confined by the first baffle 24, and thus the voltage-doubling rectifier capacitor 30 can be fixed.

In an exemplary embodiment of the present disclosure, in FIG. 1, the first baffle 24 may be disposed at the end of the bobbin sheet 21 adjacent to the voltage-doubling rectifier capacitor 30. The first baffle 24 may be connected to the bobbin sheet 21, and the first baffle 24 may be partially disposed below the bobbin sheet 21 and located at a side of the voltage-doubling rectifier capacitor 30. An outer side surface of the first baffle 24 is substantially parallel to a side of the substrate 10 adjacent to the outer side surface of the first baffle 24, which can confine the partial movement space of the voltage-doubling rectifier capacitor 30 in the horizontal direction of the circuit board 100, fixing the voltage-doubling rectifier capacitor 30. The horizontal direction of the circuit board 100 is parallel to an upper surface of the substrate 10.

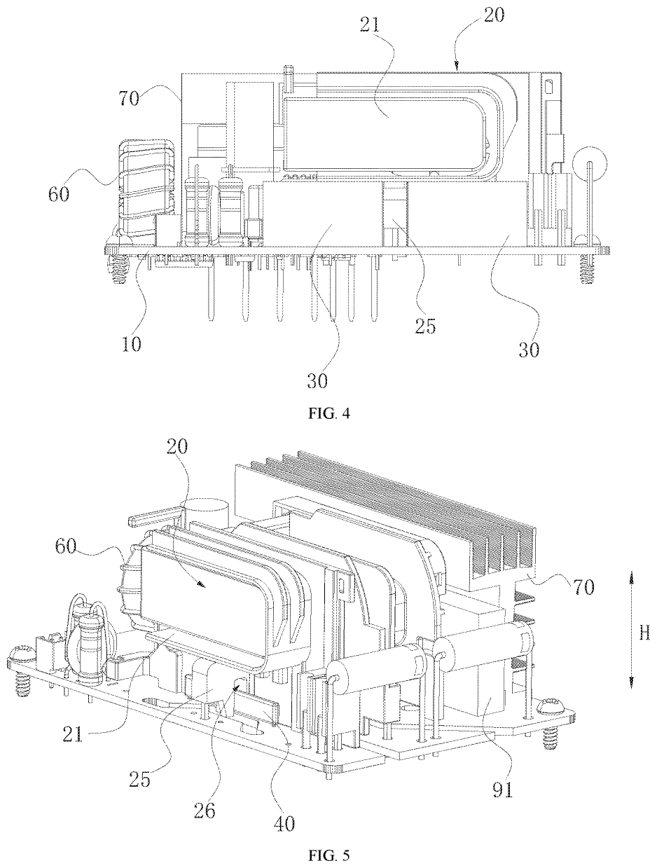

Referring to FIG. 4 and FIG. 5, in some embodiments, the transformer 20 has pin holders 25. The circuit board 100 further includes a discharge resistor 40 disposed between the pin holders 25. The pin holders 25 are configured to restrain the discharge resistor 40.

In this way, the volume of the circuit board 100 can be reduced, and a vibration resistance capability of the discharge resistor 40 can be improved.

In an exemplary embodiment of the present disclosure, the pin holders 25 may be connected to the bobbin sheet 21 and disposed below the bobbin sheet 21. The pin holders 25 may be inserted into the substrate 10. The discharge resistor 40 is disposed on the substrate 10 and located below the bobbin sheet 21. In an embodiment shown in FIG. 5, the pin holders 25 have a groove 26. The discharge resistor 40 may be disposed in the groove 26. The pin holders 25 may be disposed adjacent to a center of the discharge resistor 40. In an embodiment, the discharge resistor 40 may be inserted into the substrate 10, and then the transformer 20 is mounted. The pin holders 25 then clamp the discharge resistor 40 through the groove 26, to confine the movement space of the discharge resistor 40 in the H direction of the circuit board 100. In this way, the vibration resistance capability of the discharge resistor 40 can be improved, and the volume of the circuit board 100 can be reduced by disposing the discharge resistor 40 below the bobbin sheet 21. In addition, in an embodiment shown in FIG. 4, the discharge resistor 40 is fixed below the bobbin sheet 21 by the pin holders 25, to allow the discharge resistor 40 to abut against the substrate 10, which can stably fix the discharge resistor 40 and thus prevent pins of the discharge resistor 40 from breaking during soldering.

Referring to FIG. 3, in some embodiments, the circuit board 100 includes a bus capacitor 50 and a differential mode inductor 60. The bus capacitor 50 is disposed between the differential mode inductor 60 and the transformer 20. The differential mode inductor 60 and the bus capacitor 50 are sequentially arranged on the substrate 10.

In this way, a width of the circuit board 100 can be reduced, reducing the volume of the circuit board 100.

In an exemplary embodiment of the present disclosure, in the embodiment shown in FIG. 3, a width direction of the circuit board 100 may be denoted by D. The differential mode inductor 60 may be disposed adjacent to a side of the circuit board 100 in the D direction of the circuit board 100. The bus capacitor 50 may be disposed between the differential mode inductor 60 and the bobbin sheet 21. The differential mode inductor 60 and the bus capacitor 50 may be arranged sequentially on the substrate 10 in a direction perpendicular to the D direction. In this way, the width of the circuit board 100 can be reduced, and thus the volume of the circuit board 100 can be reduced.

Referring to FIG. 1 and FIG. 3, in some embodiments, the circuit board 100 includes a heat sink 70 disposed away from a center of the circuit board 100 and a resonant capacitor 91 disposed between a part of the heat sink 70 and the substrate 10. The heat sink 70 is configured to reduce a temperature of the resonant capacitor 91.

In this way, heat dissipation can be performed on the resonant capacitor 91, and the volume of the circuit board 100 can be further reduced.

In an exemplary embodiment of the present disclosure, in the embodiment shown in FIG. 3, the heat sink 70 may be disposed away from the center of the circuit board 100. In FIG. 1, the heat sink 70 may have a T-shaped structure and may cooperate with the substrate 10 to form a receiving space 92. The resonant capacitor 91 may be inserted into the substrate 10 and located within the receiving space 92. Since the resonant capacitor 91 is disposed in the receiving space 92, the heat dissipation can be performed on top and side surfaces of the resonant capacitor 91, which can improve heat dissipation efficiency and further reduce the volume of the circuit board 100.

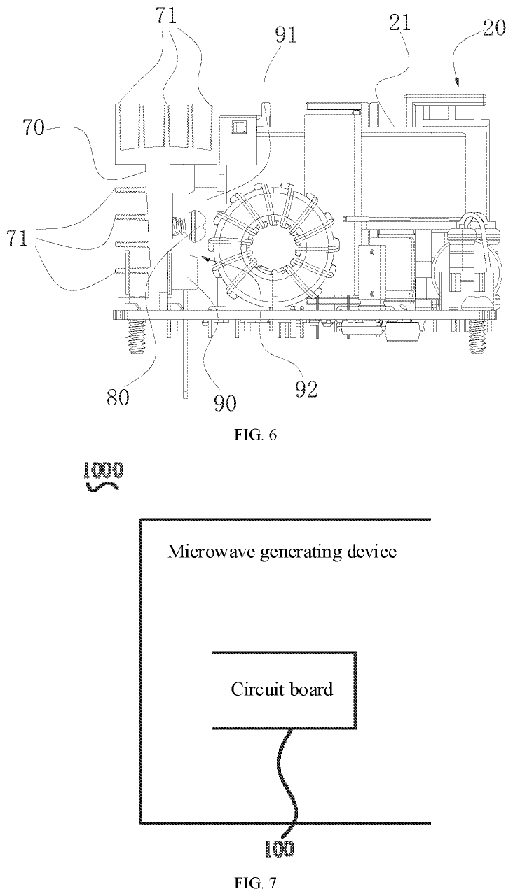

Referring to FIG. 6, in some embodiments, the circuit board 100 includes a power device 90 detachably connected to a side surface of the heat sink 70.

In this way, the heat dissipation efficiency of the power device 90 can be improved, and maintenance and replacement can be facilitated.

In an exemplary embodiment of the present disclosure, in an embodiment shown in FIG. 6, the circuit board 100 further includes a screw 80. The power device 90 may be inserted into the substrate 10 and fixedly mounted at the side surface of the heat sink 70 via the screw 80. The power device 90 is fixedly connected to the side surface of the heat sink 70, which can improve the heat dissipation efficiency of the power device 90. In an embodiment, when the power device 90 fails, the screw 80 may be loosened to facilitate replacement of the power device 90. It should be noted that the number of screws 80 may be two, and the two screws 80 may be disposed at two ends of the power device 90. In other embodiments, the number of screws 80 may also be four or other quantities, and is not specifically limited herein.

In addition, in the embodiment shown in FIG. 6, the power device 90 may also be disposed in the receiving space 92, which is also beneficial to the miniaturization of the circuit board 100.

Referring to FIG. 6, in some embodiments, the heat sink 70 includes a plurality of heat sink fins 71. The plurality of heat sink fins 71 is configured to increase a contact area with air.

In this way, heat dissipation efficiency of the heat sink 70 can be improved.

In an exemplary embodiment of the present disclosure, in FIG. 6, a plurality of heat sink fins 71 are disposed at top and side surfaces of the heat sink 70. The plurality of heat sink fins 71 may be arranged at intervals on the heat sink 70. The plurality of heat sink fins 71 are arranged at intervals on the heat sink 70, which can increase the contact area between the heat sink fins 71 and air. In this way, a heat exchange rate can be enhanced, and thus the heat dissipation efficiency of the heat sink 70 can be improved.

In addition, in other embodiments, the heat sink fins 71 disposed at the top surface of the heat sink 70 may not only be arranged perpendicular to the width direction of the circuit board 100 in its projection direction but also parallel to the width direction of the circuit board 100. The heat sink fins 71 disposed at the side surface of the heat sink 70 may not only be arranged parallel to the substrate 10 in its projection direction but also perpendicular to the substrate 10.

Referring to FIG. 2, in some embodiments, the circuit board 100 includes at least two voltage-doubling rectifier capacitors 30 symmetrically arranged in a length direction of the circuit board 100.

In this way, the volume of the circuit board 100 can be reduced, which is beneficial to the miniaturization of the circuit board 100.

In an exemplary embodiment of the present disclosure, in an embodiment shown in FIG. 2, the length direction of the circuit board 100 may be denoted by L. The circuit board 100 is provided with two voltage-doubling rectifier capacitors 30. The two voltage-doubling rectifier capacitors 30 may be symmetrically arranged on the substrate 10 in the L direction of the circuit board 100 and located below the bobbin sheet 21. In this way, a dimension of the circuit board 100 in its width direction can be reduced to some extent, which can reduce the volume of the circuit board 100, and is beneficial to the miniaturization of the circuit board 100.

Referring to FIG. 7, a microwave generating apparatus 1000 according to the embodiments of the present disclosure includes the circuit board 100 according to any one of the above embodiments.

In the above microwave generating apparatus 1000, the voltage-doubling rectifier capacitor 30 is disposed below the transformer 20 to reduce the space of the circuit board 100 occupied by the voltage-doubling rectifier capacitor 30. In this way, the volume of the circuit board 100 can be reduced, which is beneficial to the miniaturization of the circuit board 100. In addition, the voltage-doubling rectifier capacitor 30 is disposed below the transformer 20 to confine the movement of the voltage-doubling rectifier capacitor 30. In this way, the voltage-doubling rectifier capacitor 30 is prevented from floating during the soldering, which would otherwise result in the cold solder joint.

In an exemplary embodiment of the present disclosure, the microwave generating apparatus 1000 includes a variable-frequency microwave oven. The microwave generating apparatus 1000 is internally provided with a heat dissipation air duct (not shown), and the circuit board 100 may be disposed in the heat dissipation air duct. The layout of components on the circuit board 100 is reasonably designed according to the heat dissipation air duct, which can reduce the volume of the circuit board 100, making the circuit board 100 miniaturized. In this way, it is beneficial to overall design of the microwave generating apparatus 1000.

In addition, in the related art, a household appliance (such as a variable-frequency microwave oven) has a transformer. The transformer includes a magnetic core structure composed of two magnetic cores, each having a cylindrical magnetic column. The cylindrical magnetic columns of the two magnetic cores are disposed in an insulating bobbin. A primary coil and a secondary coil are respectively wound on the insulating bobbin at positions corresponding to the two cylindrical magnetic columns. An air gap is formed between the two cylindrical magnetic columns to improve the anti-saturation capability of the transformer when a resonant current flows through it. However, an outer diameter of the cylindrical magnetic core of the transformer is relatively large, resulting in a large volume of the transformer. Moreover, without changing a cross-sectional area of the magnetic core, i.e., without increasing a size of the magnetic core, it is difficult to improve the anti-saturation capability.

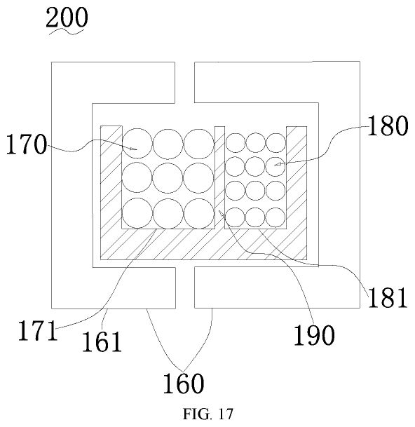

In an exemplary embodiment of the present disclosure, in the related art, referring to FIG. 16, the magnetic core 160 of the transformer 200 includes a cylindrical magnetic column 161. The cylindrical magnetic column 161 is tangent to two sides of the magnetic core 160, and is located at an outermost side of the magnetic core 160. A diameter of the cylindrical magnetic column 161 of the magnetic core 160 in the related art is relatively large, ranging from approximately 15 cm to 20 cm, which results in a large volume of the transformer 200. Without changing the cross-sectional area of the magnetic core 160, i.e., without increasing the size of the magnetic core 160, it is difficult to improve the anti-saturation capability of the transformer 200.

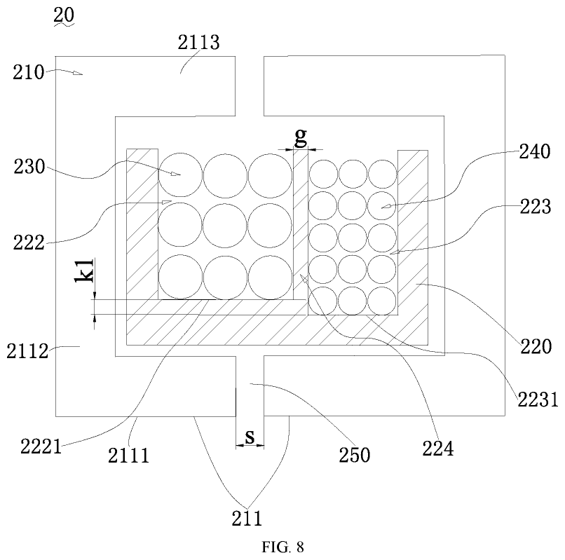

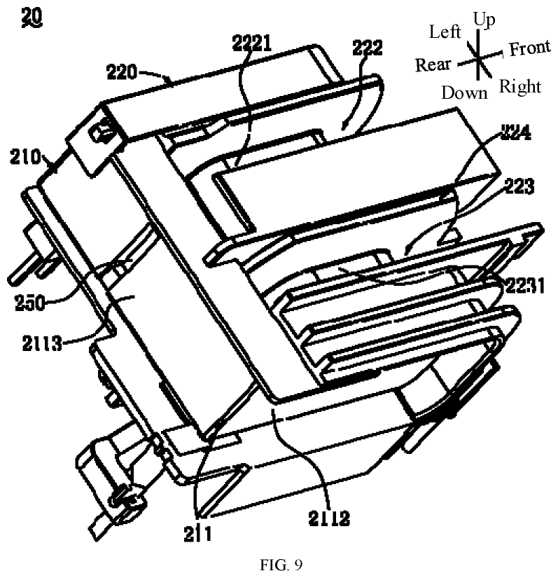

Referring to FIG. 8 to FIG. 13, the embodiments of the present disclosure provide a transformer 20. The transformer 20 includes a magnetic core structure 210, a bobbin 220, a first coil 230, and a second coil 240. The magnetic core structure 210 includes two magnetic cores 211. Each of the two magnetic cores 211 has a first magnetic column 2111 of a flat shape, and a length direction of the first magnetic column 2111 is along a length direction of the magnetic core 211. The bobbin 220 has an insertion hole 221 that fits a shape of the first magnetic column 2111. A hole wall of the insertion hole 221 has a first groove 222 and a second groove 223 that are formed on an outer side of the hole wall. The first groove 222 and the second groove 223 are spaced apart from each other. The first magnetic column 2111 is at least partially located in the insertion hole 221, and two first magnetic columns 2111 are spaced apart from each other and arranged opposite to each other. The first coil 230 is wound around the outer side of the hole wall of the insertion hole 221 and located in the first groove 222. The second coil 240 is wound around the outer side of the hole wall of the insertion hole 221 and located in the second groove 223.

In the above transformer 20, the first magnetic column 2111 is of a flat shape, and the insertion hole 221 fits the shape of the first magnetic column 2111. Without increasing the volumes of the transformer 20 and the magnetic core 211 and the cost of the transformer 20, the anti-saturation capability of the transformer 20 can be improved, and the height and volume of the transformer 20 can be further reduced, realizing miniaturization of the household appliance.

In an exemplary embodiment of the present disclosure, in an embodiment, the magnetic core structure 210 may be composed of two magnetic cores 211 mounted on the bobbin 220, forming a square frame structure. In detail, the two magnetic cores 211 are arranged opposite to each other. Moreover, the two first magnetic columns 2111 of the two magnetic cores 211 are inserted and interlocked within the insertion hole 221 of the bobbin 220 to enhance an electromagnetic induction effect, increasing magnetic induction intensities of the first coil 230 and the second coil 240 and realizing voltage conversion of the first coil 230 and the second coil 240 of the transformer 20. The transformer 20 may be applied in a frequency converter, which can also realize a miniaturized frequency converter.

The magnetic core 211 may be made of ferrite or other materials, which is not specifically limited herein. In detail, the magnetic core 211 of the transformer 20 may be formed by pressing ferrite powder to improve an anti-interference effect.

A direction where the two first magnetic columns 2111 are arranged opposite to each other is perpendicular to the height direction of the transformer 20, to reduce a height of the magnetic core 211 and the volume of the transformer 20, realizing the miniaturization of the household appliance. In addition, due to physical structure limitation of the magnetic core 211, magnetic flux passing through the magnetic core 211 cannot be infinitely increased, and saturation of the magnetic core 211 is caused under certain conditions. The saturation of the magnetic core 211 may cause overheating of the coil, posing a risk of damage or burnout of the coil or device. Therefore, in the embodiments of the present disclosure, the air gap 250 may be formed to improve the anti-saturation capability of the transformer 20.

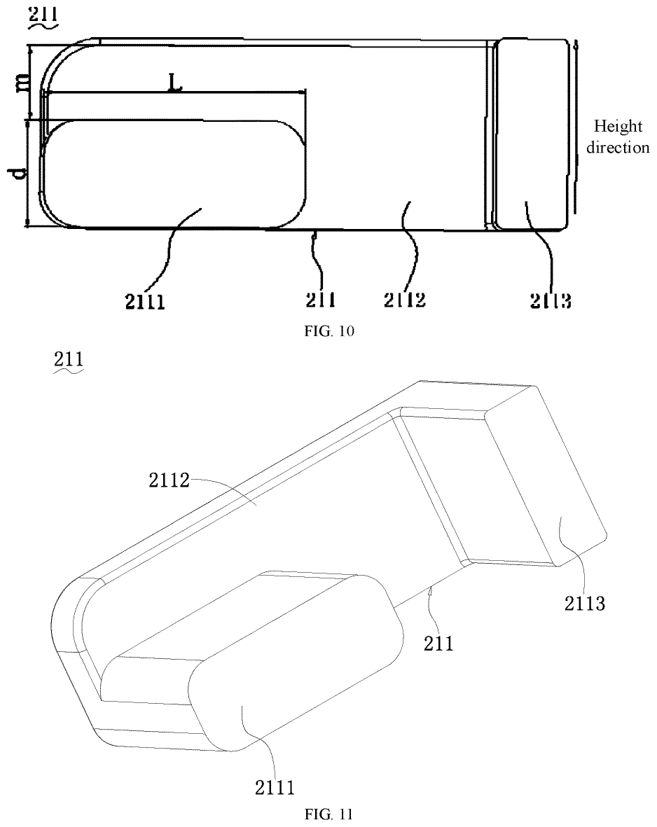

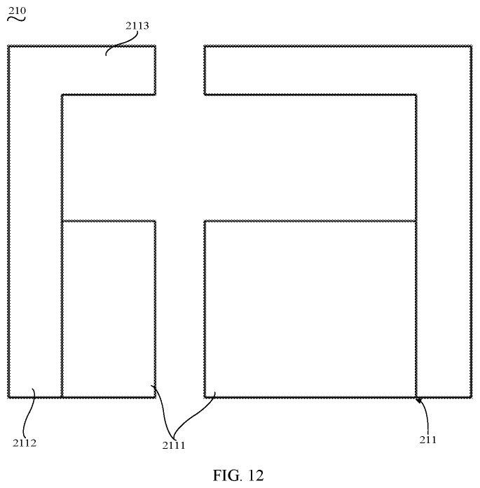

The first magnetic column 2111 is of a flat shape to reduce the height of the magnetic core 211, reducing an effective cross-sectional area of the magnetic core 211. In this way, a maximum saturation magnetic flux density is effectively lowered, the anti-saturation capability of the transformer 20 is improved, and the miniaturization of the household appliance is realized. The first magnetic column 2111 being of a flat shape can be understood that: in the height of the transformer 20 (as shown in FIG. 10), a width d of the first magnetic column 2111 is smaller than a length L of the first magnetic column 2111, and is along the height direction of the transformer 20.

The bobbin 220 may be used to support the first coil 230 and the second coil 240 of the transformer 20. In detail, the bobbin 220 may provide a winding space for the first coil 230 and the second coil 240 of the transformer 20. In addition, the bobbin 220 may also be used to fix the magnetic core 211 of the transformer 20 to provide a safe and stable voltage conversion environment. In an embodiment, the bobbin 220 may be the insulating bobbin to improve an inflaming retarding capability of the transformer 20.

In an embodiment, the insertion hole 221 may be a flat hole to fit the shape of the first magnetic column 2111, fixing the magnetic core 211 of the transformer 20.

The first coil 230 may be a primary coil, and the second coil 240 may be a secondary coil. Alternatively, the first coil 230 may be a secondary coil, and the second coil 240 may be a primary coil. It can be understood that the first groove 222 of the bobbin 220 may be used for winding the first coil 230, and the second groove 223 of the bobbin 220 may be used for winding the second coil 240. In an embodiment, a wire diameter of the second coil 240 may be smaller than a wire diameter of the first coil 230, and the number of windings of the second coil 240 may be greater than the number of windings of the first coil 230. That is, the transformer 20 may be a boosting transformer. In the transformer 20, it can be realized that a voltage of the second coil 240 is greater than a voltage of the first coil 230 to meet a voltage conversion requirement of the transformer 20.

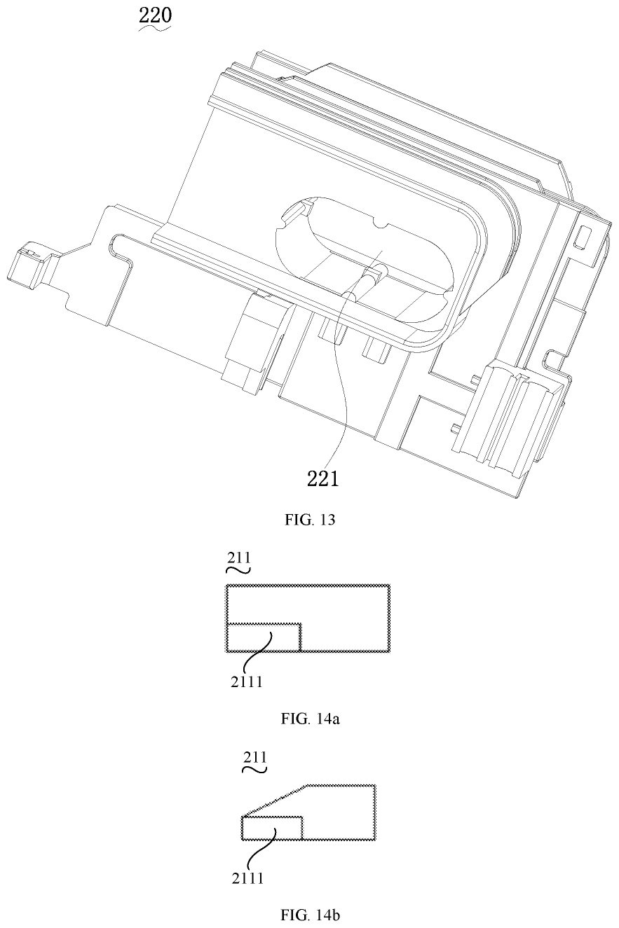

Referring to FIG. 11 and FIG. 13, in some embodiments, the magnetic core 211 includes a connection portion 2112 and a second magnetic column 2113. The first magnetic column 2111 and the second magnetic column 2113 are connected to each other by the connection portion 2112. The second magnetic column 2113 is located outside the insertion hole 221, and two second magnetic columns 2113 are spaced apart from each other and arranged opposite to each other outside the first groove 222.

In this way, the first magnetic columns 2111 of the two magnetic cores 211 pass through the insertion hole 221, and form a square frame structure together with the connection portion 2112 and the second magnetic column 2113 to surround the bobbin 220, making structural assembly of the magnetic core 211 and the bobbin 220 firmer.

In an exemplary embodiment of the present disclosure, in an embodiment, the first magnetic column 2111 may be perpendicular to the connection portion 2112, and the second magnetic column 2113 may be perpendicular to the connection portion 2112. Moreover, the first magnetic column 2111 and the second magnetic column 2113 are spaced apart from each other to ensure that the magnetic core 211 passes through and surrounds the bobbin 220 from the insertion hole 221 in a square frame structure, ensuring that the structural assembly of the magnetic core 211 and the bobbin 220 is firmer.

The first magnetic column 2111 and the second magnetic column 2113 are connected to each other by the connection portion 2112. The connection portion 2112 may be used to support and stabilize the first magnetic column 2111 and the second magnetic column 2113. In an embodiment, the connection portion 2112 may form an interference fit with a side wall of the bobbin 220, further improving stability of the assembly of the magnetic core 211 and the bobbin 220.

In an embodiment, each of the first magnetic column 2111 and the insertion hole 221 may have a flat structure, which allows the first magnetic column 2111 and the insertion hole 221 to be tightly fitted and not easily separated from each other.

That is, the first magnetic columns 2111 of the two magnetic cores 211 pass through the insertion hole 221, and form a square frame structure together with the connection portion 2112 and the second magnetic column 2113 to surround the bobbin 220, making the structural assembly of the magnetic core 211 and the bobbin 220 firmer.

Referring to FIG. 9 and FIG. 10, in some embodiments, in a height direction of the transformer 20, a distance between an upper edge of the first magnetic column 2111 and an upper edge of the connection portion 2112 is m, where m=(L/k−1)*d, in which k ranges from 5 to 20, L represents a length of the first magnetic column, and d represents a width of the first magnetic column.

In this way, the formula m=(L/k−1)*d can be used to limit value ranges of the length L of the first magnetic column 2111, the width d of the first magnetic column 2111, and the distance m in the magnetic core, to ensure the realization of the miniaturization of the household appliance without increasing the volume and cost of the transformer 20.

In an exemplary embodiment of the present disclosure, the first magnetic column 2111 is vertically connected to the connection portion 2112, and the height of the transformer 20 may change with different values of the width d of the first magnetic column 2111. In detail, it is assumed that the width d of the first magnetic column 2111 increases, a height of the bobbin 220 of the transformer 20 increases, which increases an occupied space by the height and volume of the transformer 20, increasing production costs. It is assumed that the width d of the first magnetic column 2111 decreases, the height of the bobbin 220 of the transformer 20 decreases, which reduces the occupied space by the height and volume of the transformer 20, realizing the miniaturization of the household appliance.

The formula m=(L/k−1)*d may be used to limit the value ranges of the length L of the first magnetic column 2111, the width d of the first magnetic column 2111, and the distance m in the magnetic core, to ensure the realization of the miniaturization of the household appliance without increasing the volume and cost of the transformer 20.

In an embodiment, the length L of the first magnetic column 2111 of the magnetic core 211 may be 20 mm, the width d of the first magnetic column 2111 may be 8 mm, and the distance m between the upper edge of the first magnetic column 2111 and the upper edge of the connection portion 2112 may be 10 mm. According to the formula m=(L/k−1)*d, it can be calculated that k is 8.9. In an embodiment, k may range from 5 to 20.

That is, the formula m=(L/k−1)*d may be used to limit the value ranges of the length L of the first magnetic column 2111, the width d of the first magnetic column 2111, and the distance m in the magnetic core, to ensure the realization of the miniaturization of the household appliance without increasing the volume and cost of the transformer 20.

In some embodiments, a ratio of a length L of the first magnetic column 2111 to a width d of the first magnetic column 2111 ranges from 2 to 40.

In this way, through the ratio L/d of the length L of the first magnetic column 2111 to the width d of the first magnetic column 2111, it is ensured that the width d of the first magnetic column 2111 is within a small range, effectively lowering the maximum saturation magnetic flux density and improving safety performance of the transformer 20.

In an exemplary embodiment of the present disclosure, the ratio L/d of the length L of the first magnetic column 2111 to the width d of the first magnetic column 2111 is selected to range from 2 to 40. In this way, it is ensured that the width d of the first magnetic column 2111 is within a small range to effectively lower the maximum saturation magnetic flux density.

In detail, theoretical alternating magnetic flux may generate an induced current on a cross-sectional area of conductor of the magnetic core 211. According to Lenz's law, a magnetic field generated by the induced current always opposes a change in magnetic flux that causes the induced current, making the magnetic flux tend to a surface of the magnetic core 211, resulting in a reduction in the effective cross-sectional area of the magnetic core 211. This phenomenon is also known as a skin effect of the magnetic core.

In addition, the power magnetic core 211 has a hysteresis characteristic. For a part of the magnetic core 211 having a cross-section with a large magnetic flux density, its corresponding magnetic permeability decreases. That is, when the magnetic core 211 is excited by a predetermined current, an inductance value per winding decreases, and the anti-saturation capability of the magnetic core 211 decreases.

In an embodiment, when the cross-sectional area of the magnetic core 211 is kept the same, the skin effect of the magnetic core 211 may be reduced by reducing the width d of the flat cross-section of the magnetic core, which can effectively lower the maximum saturation magnetic flux density.

In an embodiment, the ratio L/d of the length L of the first magnetic column 2111 to the width d of the first magnetic column 2111 is selected to range from 2 to 40, i.e., 2≤L/d≤40. In an example, the ratio L/d may be 2, 7, 16, 23, 27, 34, 40, or other values ranging from 2 to 40.

That is, through the ratio L/d of the length L of the first magnetic column 2111 to the width d of the first magnetic column 2111, it is ensured that the width d of the first magnetic column 2111 is within a small range, effectively lowering the maximum saturation magnetic flux density and improving the safety performance of the transformer 20.

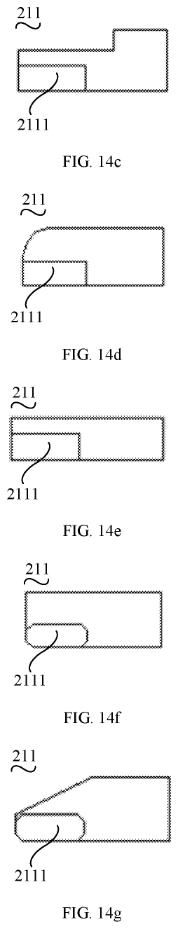

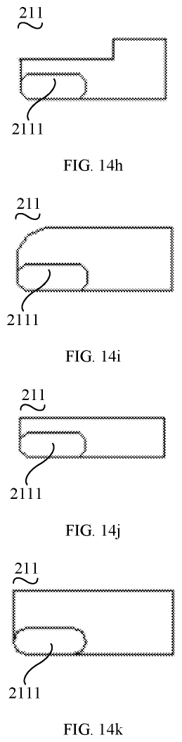

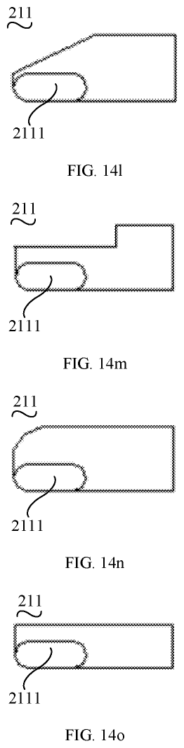

In an embodiment, a cross-sectional diagram of the magnetic core 211 includes, but is not limited to, a structural shape shown in FIG. 10. As shown in FIG. 14a to FIG. 140, the connection portion 2112 of the magnetic core 211 may also have a rectangular cross-section, a polygonal cross-section, or a special-shaped cross-section, which is not specifically limited herein.

Referring to FIG. 10, in some embodiments, d range from 5 mm to 12 mm.

In this way, the width d of the first magnetic column 2111 is selected to range from 5 mm to 12 mm to reduce the height of the magnetic core and the height of the transformer 20, effectively lowering the maximum saturation magnetic flux density.

In an exemplary embodiment of the present disclosure, the width d of the first magnetic column 2111 should be selected within an appropriate range to ensure that the maximum saturation magnetic flux density is effectively lowered while reducing the height of the transformer 20.

When the selected width d of the first magnetic column 2111 is too small, it is insufficient to lower the maximum saturation magnetic flux density. When the selected width d of the first magnetic column 2111 is too large, a volume occupied by the transformer 20 increases, increasing the cost.

In an embodiment, the width d of the first magnetic column 2111 is selected to range from 5 mm to 12 mm.

The width d of the first magnetic column 2111 is selected to range from 5 mm to 12 mm, i.e., 5 mm≤d≤12 mm. In an example, the width d may be 5 mm, 6 mm, 8 mm, 9 mm, 10 mm, 11 mm, 12 mm, or other values ranging from 5 mm to 12 mm.

That is, the width d of the first magnetic column 2111 is selected to range from 5 mm to 12 mm to ensure that the maximum saturation magnetic flux density is effectively lowered while reducing the height of the transformer 20.

Referring to FIG. 8 and FIG. 9, in some embodiments, the first coil 230 is a primary coil, and the second coil 240 is a secondary coil. The two first magnetic columns 2111 are spaced apart from each other and arranged opposite to each other to form an air gap 250. The air gap 250 is located adjacent to the first coil 230.

In this way, the air gap 250 is formed to improve the anti-saturation capability of the transformer 20 when the resonant current flows through it, reduce damage to the device, and thus provide a stable operating environment for the transformer 20.

In an exemplary embodiment of the present disclosure, in an embodiment, the air gap 250 may be a gap between the two first magnetic columns 2111 arranged opposite to each other or a gap between the two second magnetic columns 2113 arranged opposite to each other, or may be formed in other ways, which is not specifically limited herein.

The air gap 250 may be located at a side of the first coil 230, and may be used to improve the anti-saturation capability of the transformer 20 when the resonant current flows through it, reduce the damage to the device, and thus provide the stable operating environment for the transformer 20.

That is, the transformer 20 has the air gap 250 to prevent the transformer 20 from generating magnetic saturation during its operation, reduce the damage to device, and thus provide the stable operating environment for the transformer 20.

Referring to FIG. 8, in some embodiments, a width s of the air gap ranges from 1.5 mm to 3.2 mm.

In this way, by setting the width s of the air gap 250 to range from 1.5 mm to 3.2 mm, the anti-saturation capability of the transformer 20 is improved. Moreover, device loss of the transformer 20 can be reduced, and a safe operating environment for the transformer 20 can be ensured.

In an exemplary embodiment of the present disclosure, the width s of the air gap 250 should be selected within an appropriate range to ensure normal operation of the transformer 20.

When the selected width s of the air gap 250 is too small, the anti-saturation capability of the transformer 20 is insufficient. When the selected width s of the air gap 250 is too large, copper loss of the transformer 20 increases.

In an embodiment, the width s of the air gap 250 is selected to range from 1.5 mm to 3.2 mm.

The width s of the air gap 250 is selected to range from 1.5 mm to 3.2 mm, i.e., 1.5mm≤s≤3.2mm. In an example, the width s may be 1.5 mm, 1.7 mm, 1.8 mm, 2.0 mm, 2.3 mm, 2.6 mm, 3.2 mm, or other values ranging from 1.5 mm to 3.2 mm.

That is, by setting the width s of the air gap 250 to range from 1.5 mm to 3.2 mm, the anti-saturation capability of the transformer 20 is improved. Moreover, the device loss of the transformer 20 can be reduced, and the safe operating environment for the transformer 20 can be ensured.

Referring to FIG. 8 and FIG. 9, in some embodiments, the bobbin 220 includes a second baffle 224. The first groove 222 is separated from the second groove 223 by the second baffle 224, and a thickness g of the second baffle 224 ranges from 3.5 mm to 5 mm.

In this way, on the one hand, the first coil 230 is separated from the second coil 240 by the second baffle 224 to reduce a safety hazard. On the other hand, the bobbin 220 can adjust leakage inductance and a coupling coefficient of the transformer 20 by adjusting the thickness g of the second baffle 224.

In an exemplary embodiment of the present disclosure, the second baffle 224 is disposed between the first groove 222 and the second groove 223 at the outer side of the hole wall of the insertion hole 221. The first coil 230 is separated from the second coil 240 by the second baffle 224 to prevent the first coil 230 and the second coil 240 from being entangled with each other, reducing the safety hazard.

In an embodiment, the second baffle 224 may be made of an insulating material to improve inflaming retarding performance of the bobbin 220.

In an embodiment, the thickness g of the second baffle 224 is selected to range from 3.5 mm to 5 mm. The bobbin 220 may adjust the leakage inductance and coupling coefficient of the transformer 20 by adjusting the thickness g of the second baffle 224. In detail, the thickness g of the second baffle 224 is selected to range from 3.5 mm to 5 mm. As the thickness g of the second baffle 224 increases, the leakage inductance of the transformer 20 increases, and the coupling coefficient between the first coil 230 and the second coil 240 decreases. As the thickness g of the second baffle 224 decreases, the leakage inductance of the transformer 20 decreases, and the coupling coefficient between the first coil 230 and the second coil 240 increases.

The thickness g is selected to range from 3.5 mm to 5 mm, i.e., 3.5 mm≤g≤5 mm. In an example, the thickness g may be 3.5 mm, 3.7 mm, 3.8 mm, 4.0 mm, 4.3 mm, 4.6 mm, 5 mm, or other values ranging from 3.5 mm to 5 mm.

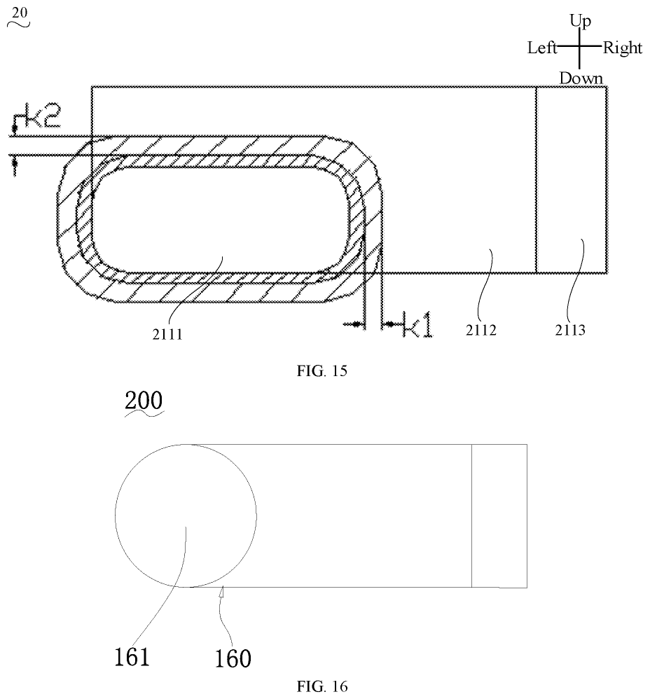

Referring to FIG. 9 and FIG. 15, in some embodiments, a bottom surface of the first groove 222 serves as a first winding surface 2221, and a bottom surface of the second groove 223 serves as a second winding surface 2231. A height difference exists between the first winding surface 2221 and the second winding surface 2231 in a radial direction of the insertion hole 221.

In this way, by setting a height of the first winding surface 2221 to be greater than a height of the second winding surface 2231, magnetic flux from the first coil 230 to the second coil 240 is reduced, lowering the coupling coefficient between the first coil 230 and the second coil 240.

In an exemplary embodiment of the present disclosure, in an embodiment, the first winding surface 2221 may be used for winding the primary coil, and the second winding surface 2231 may be used for winding the secondary coil. Further, the first winding surface 2221 is separated from the second winding surface 2231 by the second baffle 224 to improve safety of the winding of the transformer 20.

As shown in FIG. 8, the radial direction of the insertion hole 221 may be a direction radiating 360° outwards from a center of the first magnetic column 2111. It can be understood that the height of the first winding surface 2221 in the radial direction of the insertion hole 221 is greater than the height of the second winding surface 2231 in the radial direction of the insertion hole 221, to reduce the magnetic flux from the first coil 230 to the second coil 240, lowering the coupling coefficient between the first coil 230 and the second coil 240.

In an embodiment, referring to FIG. 15, a height difference k2 exists between the first winding surface 2221 and the second winding surface 2231 in an up-down direction. A height difference k1 exists between the first winding surface 2221 and the second winding surface 2231 in a left-right direction.

In other embodiments, surface areas of four different planes of the first winding surface 2221 may each be greater than surface areas of corresponding four different planes of the second winding surface 2231. In other embodiments, the surface areas of two of the four planes of the first winding surface 2221 may each be greater than the surface areas of the corresponding two planes of the second winding surface 2231, which is not specifically limited herein.

That is, in the radial direction of the insertion hole 221, the height of the first winding surface 2221 is greater than the height of the second winding surface 2231, to reduce the magnetic flux from the first coil 230 to the second coil 240, lowering the coupling coefficient between the first coil 230 and the second coil 240.

In an embodiment, the length L of the first magnetic column 2111 of the magnetic core 211 may be 20 mm, the width d of the first magnetic column 2111 may be 8 mm, the distance m between the upper edge of the first magnetic column 2111 and the upper edge of the connection portion 2112 may be 10 mm, the thickness g of the first baffle may be 5 mm, the number of windings of the primary coil may be 30, the number of windings of the secondary coil may be 250, and the width s of the air gap may be 2.2 mm.

The embodiments of the present disclosure also provide a household appliance. The household appliance includes the transformer 20 according to any one of the above embodiments.

In the above household appliance, the first magnetic column 2111 is of a flat shape, and the insertion hole 221 fits the shape of the first magnetic column 2111. Without increasing the volumes of the transformer 20 and the magnetic core 211 and the cost of the transformer 20, the anti-saturation capability of the transformer 20 can be improved. Moreover, the height and volume of the transformer 20 can be further reduced, realizing the miniaturization of the household appliance.

It should be noted that the above explanations of the embodiments and beneficial effects of the transformer 20 are also applicable to the household appliance of the embodiments of the present disclosure, and details thereof are omitted herein for the avoidance of redundancy.

The household appliance includes, but is not limited to, a microwave oven, a combination steam and bake oven, an air conditioner, or a dishwasher. The household appliance is widely used in food cooking, tableware cleaning, and the like.

In addition, a current transformer for the variable-frequency microwave oven includes a magnetic core structure composed of two magnetic cores, each having a cylindrical magnetic column. The cylindrical magnetic columns of the two magnetic cores are sleeved in an insulating bobbin. A primary coil and a secondary coil are respectively wound on the insulating bobbin at positions corresponding to the two cylindrical magnetic columns. The leakage inductance and coupling coefficient between the primary coil and the secondary coil are adjusted by changing a thickness of a gap baffle.

Since the leakage inductance in the above transformer directly affects a hard switching characteristic of IGBT, especially when the microwave oven operates at low power, a relatively low coupling coefficient (relatively great leakage inductance energy) is particularly required to provide a reverse current of a resonant cavity, realizing zero-voltage conduction of the IGBT. However, in the above solution, without changing the thickness of the baffle, the number of windings, or other factors that increase the volume and cost of the transformer, the coupling coefficient cannot be further reduced to adapt to low-power application.

In an exemplary embodiment of the present disclosure, in the related art, referring to FIG. 17, a height of a first plane 171 where the primary coil 170 is wound is the same as a height of a second plane 181 where the secondary coil 180 is wound. Therefore, in the related art, without changing the thickness of the baffle 190, the number of windings of the coil, or the like, the coupling coefficient of the transformer 200 cannot be further reduced to adapt to low-power application.

Referring to FIG. 8 to FIG. 13, the embodiments of the present disclosure provide a transformer 20. The transformer 20 includes a magnetic core structure 210, a bobbin 220, a first coil 230, and a second coil 240. The magnetic core structure 210 includes two magnetic cores 211. Each of the two magnetic cores 211 has a first magnetic column 2111. The bobbin 220 has an insertion hole 221 that fits a shape of the first magnetic column 2111. A hole wall of the insertion hole 221 has a first groove 222 and a second groove 223 that are formed on an outer side of the hole wall. The first groove 222 and the second groove 223 are spaced apart from each other. The first magnetic column 2111 is at least partially located in the insertion hole 221, and two first magnetic columns 2111 are spaced apart from each other and arranged opposite to each other. A bottom surface of the first groove 222 serves as a first winding surface 2221, and a bottom surface of the second groove 223 serves as a second winding surface 2231. A height difference exists between the first winding surface 2221 and the second winding surface 2231 in a radial direction of the insertion hole 221. The first coil 230 is wound on the first winding surface 2221 and located in the first groove 222. The second coil 240 is wound on the second winding surface 2231 and located in the second groove 223.

In the above transformer 20, the first coil 230 is wound on the first winding surface 2221, and the second coil 240 is wound on the second winding surface 2231. The height difference exists between the first winding surface 2221 and the second winding surface 2231 in the radial direction of the insertion hole 221. As a result, the first coil 230 and the second coil 240 are wound in a staggered manner. In this way, the coupling coefficient can be reduced, and the hard switching characteristic of the IGBT at low power can be reduced, thus enabling adaptation to low-power application.

In an exemplary embodiment of the present disclosure, in an embodiment, the magnetic core structure 210 may be composed of two magnetic cores 211 arranged opposite to each other on the bobbin 220, forming a square frame structure.

The magnetic core 211 may be made of ferrite or other materials, which is not specifically limited herein. In detail, the magnetic core 211 may be formed by pressing ferrite powder, and may be applied in a high-frequency transformer 20 to increase magnetic permeability, improving a quality factor of the inductor and reducing coil loss.

The first magnetic column 2111 may be of a flat shape or other shapes, which is not specifically limited herein. The insertion hole 221 fits the shape of the first magnetic column 2111 to ensure that the two first magnetic columns 2111 of the two magnetic cores 211 are inserted and interlocked within the insertion hole 221 of the bobbin 220 to enhance the electromagnetic induction effect.

The bobbin 220 may be used to support and separate the first coil 230 and the second coil 240 of the transformer 20. In detail, the bobbin 220 may provide the winding space for the first coil 230 and the second coil 240 of the transformer 20. In addition, the bobbin 220 may also be used to fix the magnetic core 211 of the transformer 20 to provide the safe and stable voltage conversion environment. In an embodiment, the bobbin 220 may be the insulating bobbin to improve the inflaming retarding capability of the transformer 20.

The first winding surface 2221 of the first groove 222 of the bobbin 220 is used for winding the first coil 230, and the second winding surface 2231 of the second groove 223 is used for winding the second coil 240. In this way, the first coil 230 and the second coil 240 are located in different winding spaces, reducing a safety hazard caused by mutual entanglement of the coils and improving the safety performance of the transformer 20.

The wire diameter of the second coil 240 may be smaller than the wire diameter of the first coil 230, and the number of windings of the second coil 240 may be greater than the number of windings of the first coil 230. That is, the transformer 20 may be the boosting transformer. In the transformer 20, it can be realized that the voltage of the second coil 240 is greater than the voltage of the first coil 230 to meet the voltage conversion requirement of the transformer 20. In an embodiment, the first coil 230 may be a primary coil, and the second coil 240 may be a secondary coil. Alternatively, the first coil 230 may be a secondary coil, and the second coil 240 may be a primary coil.

In an embodiment, as shown in FIG. 8, the height of the first winding surface 2221 in the radial direction of the insertion hole 221 may be greater than the height of the second winding surface 2231 in the radial direction of the insertion hole 221. The height difference k1 exists between the first winding surface 2221 and the second winding surface 2231 in the radial direction of the insertion hole 221, resulting in the occurrence of an additional leakage flux space with a spacing k1 between the first coil 230 and the first magnetic column 2111. That is, the greater the spacing k1, the greater leakage flux energy of the first coil 230, and the less the magnetic flux from the first coil 230 to the second coil 240. In this way, the coupling coefficient between the first coil 230 and the second coil 240 in the transformer 20 is reduced, which allows a temperature rise of the power device of the transformer 20 to be reduced, reducing the hard switching characteristic of the IGBT when the transformer 20 operates at low power, and improving reliability of the transformer 20.

In another embodiment, the height of the second winding surface 2231 in the radial direction of the insertion hole 221 may be greater than the height of the first winding surface 2221 in the radial direction of the insertion hole 221 (not shown). The height difference k1 exists between the first winding surface 2221 and the second winding surface 2231 in the radial direction of the insertion hole 221, resulting in the occurrence of an additional leakage flux space with a spacing k1 between the second coil 240 and the first magnetic column 2111. That is, the greater the spacing k1, the greater leakage flux energy of the second coil 240, and the less the magnetic flux from the second coil 240 to the first coil 230. In this way, the coupling coefficient between the first coil 230 and the second coil 240 in the transformer 20 is reduced, which allows the temperature rise of the power device of the transformer 20 to be reduced, reducing the hard switching characteristic of the IGBT when the transformer 20 operates at low power, and improving the reliability of the transformer 20.

In an embodiment, in the embodiments of the present disclosure, the air gap 250 may be formed to improve the anti-saturation capability of the transformer 20. In detail, due to the physical structure limitation of the magnetic core 211, the magnetic flux passing through the magnetic core 211 cannot be infinitely increased, and the saturation of the magnetic core 211 is caused under certain conditions. The saturation of the magnetic core 211 may cause the overheating of the coil, posing the risk of the damage or burnout of the coil or device. Therefore, the air gap 250 may be formed to improve the anti-saturation capability of the transformer 20.

When the width s of the air gap 250 is too small, the anti-saturation capability of the transformer 20 is insufficient. When the width s of the air gap 250 is too large, the copper loss of the transformer 20 increases. Therefore, the width s of the air gap 250 may be selected to range from 1.5 mm to 3.2 mm, i.e., 1.5 mm≤s≤3.2 mm. In an example, the width s may be 1.5 mm, 1.7 mm, 1.8 mm, 2.0 mm, 2.3 mm, 2.6 mm, 3.2 mm, or other values ranging from 1.5 mm to 3.2 mm.

Referring to FIG. 15, in some embodiments, the height difference ranges from 0.5 mm to 4 mm.

In this way, by setting an appropriate height difference between the first winding surface 2221 and the second winding surface 2231, the height of the transformer 20 is reduced, and the coupling coefficient of the transformer 20 is decreased, reducing the hard switching characteristic of the IGBT when the transformer 20 operates at low power.

In an exemplary embodiment of the present disclosure, the height difference may include a first height difference k1 in a length direction of the radial cross-section of the insertion hole 221 and a second height difference k2 in a width direction of the radial cross-section of the insertion hole 221, or may only have the first height difference k1 or the second height difference k2, which is not specifically limited herein. That is, a height of the first winding surface 2221 along the radial cross-section of the insertion hole 221 is greater than a height of the second winding surface 2231 along the radial cross-section of the insertion hole 221, which allows the magnetic flux from the first coil 230 to the second coil 240 to be reduced, lowering the coupling coefficient between the first coil 230 and the second coil 240.

The height difference should be selected within an appropriate range to reduce the height of the transformer 20. Meanwhile, the coupling coefficient of the transformer 20 can be reduced.

When the height difference is too small, the coupling coefficient of the transformer 20 cannot be effectively reduced. When the height difference is too large, the height of the transformer 20 increases, resulting in an increase in the volume and occupied space of the transformer 20.

In an embodiment, the first height difference k1 is selected to range from 0.5 mm to 4 mm, i.e., 0.5mm≤k1≤4 mm. In an example, the first height difference k1 may be 0.5 mm, 0.8 mm, 1.3 mm, 2.7 mm, 3.2 mm, 3.6 mm, 4 mm, or other values ranging from 0.5 mm to 4 mm.

The second height difference k2 may be selected to range from 0.5 mm to 4 mm, i.e., 0.5mm≤k2≤4 mm. In an example, the second height difference k2 may be 0.5 mm, 0.7 mm, 1.4 mm, 2.3 mm, 3.5 mm, 3.9 mm, 4 mm, or other values ranging from 0.5 mm to 4 mm.

Referring to FIG. 13, the radial direction of the insertion hole 221 is parallel to a plane of the drawing. An axial direction of the insertion hole 221 is perpendicular to the plane of the drawing. A circumferential direction of the insertion hole 221 is a direction rotating around the axial direction of the insertion hole 221 in a plane parallel to the plane of the drawing.

Referring to FIG. 13 and FIG. 15, in some embodiments, the height difference exists over a circumference of the insertion hole 221 by 360°.

In this way, the height difference exists between the first winding surface 2221 and the second winding surface 2231 over the circumference of the insertion hole 221 by 360°, resulting in a staggered winding height between the first coil 230 and the second coil 240. In this way, the coupling coefficient between the first coil 230 and the second coil 240 is reduced, and the hard switching characteristic of the IGBT when the transformer 20 operates at low power is reduced.

In an exemplary embodiment of the present disclosure, referring to FIG. 15, in an embodiment, any height of the first winding surface 2221 over the circumference of the insertion hole 221 by 360° may be greater than any height of the second winding surface 2231 over the circumference of the insertion hole 221 by 360°.

In detail, a height of a first groove 222 where the first winding surface 2221 is located may be greater than a height of a second groove 223 where the second winding surface 2231 is located. That is, a height difference k1 exists between the first winding surface 2221 and the second winding surface 2231 in the radial direction of the insertion hole 221, and a height difference k2 exists between the first winding surface 2221 and the second winding surface 2231 in the axial direction of the insertion hole 221. In this way, additional leakage flux spaces with spacings k1 and k2 exist between the first coil 230 and the first magnetic column 2111. That is, the greater the spacings k1 and k2, the greater the leakage flux energy of the first coil 230, and the less the magnetic flux from the first coil 230 to the second coil 240. In this way, the coupling coefficient between the first coil 230 and the second coil 240 in the transformer 20 is reduced, which allows the temperature rise of the power device of the transformer 20 to be reduced, reducing the hard switching characteristic of the IGBT when the transformer 20 operates at low power, and improving the reliability of the transformer 20.

In another embodiment, any height of the first winding surface 2221 over the circumference of the insertion hole 221 by 360° may be smaller than any height of the second winding surface 2231 over the circumference of the insertion hole 221 by 360°.

In detail, the height of the first groove 222 where the first winding surface 2221 is located may be smaller than the height of the second groove 223 where the second winding surface 2231 is located. That is, the height difference k1 exists between the first winding surface 2221 and the second winding surface 2231 in the radial direction of the insertion hole 221, and the height difference k2 exists between the first winding surface 2221 and the second winding surface 2231 in the axial direction of the insertion hole 221. In this way, the additional leakage flux spaces with the spacings k1 and k2 exist between the second coil 240 and the first magnetic column 2111. That is, the greater the spacings k1 and k2, the greater the leakage flux energy of the second coil 240, and the less the magnetic flux from the second coil 240 to the first coil 230. In this way, the coupling coefficient between the first coil 230 and the second coil 240 in the transformer 20 is reduced, which allows the temperature rise of the power device of the transformer 20 to be reduced, reducing the hard switching characteristic of the IGBT when the transformer 20 operates at low power, and improving the reliability of the transformer 20.

Referring to FIG. 15, in some embodiments, the insertion hole 221 is of a flat shape. A length direction of a radial cross-section of the insertion hole 221 is perpendicular to a height direction of the transformer 20. The height difference includes a first height difference k1 in the length direction of the radial cross-section of the insertion hole 221 and a second height difference k2 in a width direction of the radial cross-section of the insertion hole 221. The first height difference k1 is equal to the second height difference k2.

In this way, by setting the first height difference k1 and the second height difference k2, the staggered height between the wound first coil 230 and second coil 240 is increased, the coupling coefficient between the first coil 230 and the second coil 240 is reduced, and thus the hard switching characteristic of the IGBT when the transformer 20 operates at low power is reduced.

In an exemplary embodiment of the present disclosure, the insertion hole 221 is of a flat shape to reduce the height of the bobbin 220, which further reduces the height and volume of the transformer 20, allowing the occupied space of the transformer 20 to be reduced.

In an embodiment, the height difference includes a first height difference k1 in the length direction of the radial cross-section of the insertion hole 221 and a second height difference k2 in the width direction of the radial cross-section of the insertion hole 221. In this way, the staggered height between the wound first coil 230 and second coil 240 is increased, the coupling coefficient between the first coil 230 and the second coil 240 is reduced, and thus the hard switching characteristic of the IGBT when the transformer 20 operates at low power is reduced.

It is worth noting that the height difference includes at least one of the first height difference k1 or the second height difference k2. That is, the height difference may only include the first height difference k1, only include the second height difference k2, or include both the first height difference k1 and the second height difference k2, which is not specifically limited herein.

When the height difference includes both the first height difference k1 and the second height difference k2, the first height difference k1 may be the same as or different from the second height difference k2, which is not specifically limited herein.

Referring to FIG. 10 and FIG. 13, in some embodiments, the first magnetic column 2111 is of a flat shape that fits a shape of the insertion hole 221, and a length direction of the first magnetic column 2111 is along a length direction of the magnetic core 211.

In this way, the first magnetic column 2111 and the insertion hole 221 are fixed through their fitting flat structures. On the one hand, the height and volume of the transformer 20 can be reduced. On the other hand, the first magnetic column 2111 and the insertion hole 221 are tightly fitted, providing the stable voltage conversion environment for the transformer

In an exemplary embodiment of the present disclosure, referring to FIG. 16, in the related art, the magnetic core 60 of the transformer 200 includes a cylindrical magnetic column 61. The cylindrical magnetic column 61 is tangent to the two sides of the magnetic core 60 and is located at the outermost side of the magnetic core 60. The diameter of the cylindrical magnetic column 61 of the magnetic core 60 in the related art is relatively large, resulting in the large volume of the transformer 200. In the embodiments of the present disclosure, the first magnetic column 2111 is of a flat shape, which can reduce the height of the bobbin 220, reducing the height and volume of the transformer 20. In addition, the first magnetic column 2111 is of a flat shape, enables it to be tightly fitted with the insertion hole 221 of a flat shape and not easily be separated from the insertion hole 221 of a flat shape.

In detail, the first magnetic column 2111 is of a flat shape to reduce the height of the magnetic core 211, which reduces the effective cross-sectional area of the magnetic core 211. In this way, the maximum saturation magnetic flux density is effectively lowered, the anti-saturation capability of the transformer 20 is improved, and the miniaturization of the household appliance is realized.

The first magnetic column 2111 being of a flat shape can be understood as that: in the height of the transformer 20 (as shown in FIG. 10), the width d of the first magnetic column 2111 is smaller than the length L of the first magnetic column 2111, and the width d of the first magnetic column 2111 is along the height direction of the transformer 20.

In an embodiment, the cross-section diagram of the magnetic core 211 includes, but is not limited to, the structural shape shown in FIG. 10. As shown in FIG. 14a to FIG. 140, the connection portion 2112 of the magnetic core 211 may also have a rectangular cross-section, a polygonal cross-section, or a special-shaped cross-section, which is not specifically limited herein.

Referring to FIG. 11 and FIG. 13, in some embodiments, the magnetic core 211 includes a connection portion 2112 and a second magnetic column 2113. The first magnetic column 2111 and the second magnetic column 2113 are connected to each other by the connection portion 2112. The second magnetic column 2113 is located outside the insertion hole 221. Two second magnetic columns 2113 are spaced apart from each other and arranged opposite to each other outside the first groove 222.

In this way, the first magnetic columns 2111 of the two magnetic cores 211 pass through the insertion hole 221, and form a square frame structure together with the connection portion 2112 and the second magnetic column 2113 to surround the bobbin 220, making the structural assembly of the magnetic core 211 and the bobbin 220 firmer.

In an exemplary embodiment of the present disclosure, in an embodiment, the first magnetic column 2111 may be perpendicular to the connection portion 2112, and the second magnetic column 2113 may be perpendicular to the connection portion 2112. Moreover, the first magnetic column 2111 and the second magnetic column 2113 are spaced apart from each other to ensure that the magnetic core 211 passes through and surrounds the bobbin 220 from the insertion hole 221 in a square frame structure, ensuring that the structural assembly of the magnetic core 211 and the bobbin 220 is firmer.

The first magnetic column 2111 and the second magnetic column 2113 are connected to each other by the connection portion 2112. The connection portion 2112 may be a magnetic block, and be used to support and stabilize the first magnetic column 2111 and the second magnetic column 2113. In an embodiment, the connection portion 2112 may form an interference fit with the side wall of the bobbin 220, further improving the stability of the assembly of the magnetic core 211 and the bobbin 220.

In an embodiment, each of the first magnetic column 2111 and the insertion hole 221 may have a flat structure, which allows the first magnetic column 2111 and the insertion hole 221 to be tightly fitted and not easily separated from each other.

Referring to FIG. 9 and FIG. 10, in some embodiments, in a height direction of the transformer 20, a distance between an upper edge of the first magnetic column 2111 and an upper edge of the connection portion 2112 is m, where m=(L/k−1)*d, in which k ranges from 5 to 20, L represents a length of the first magnetic column, and d represents a width of the first magnetic column.

In this way, the formula m=(L/k−1)*d can be used to limit the value ranges of the length L of the first magnetic column 2111, the width d of the first magnetic column 2111, and the distance m in the magnetic core, to ensure the effective reduction in the saturation magnetic flux density and the realization of the miniaturization of the household appliance without increasing the volume and cost of the transformer 20.

In an exemplary embodiment of the present disclosure, the first magnetic column 2111 is vertically connected to the connection portion 2112, and the height of the transformer 20 may change with the different values of the width d of the first magnetic column 2111.

When the selected width d of the first magnetic column 2111 is too small, it is insufficient to lower the maximum saturation magnetic flux density. When the selected width d of the first magnetic column 2111 is too large, the volume occupied by the transformer 20 increases, increasing the cost.

In an embodiment, the width d of the first magnetic column 2111 is selected to range from 5 mm to 12 mm, i.e., 5 mm≤d≤12 mm, to ensure that the maximum saturation magnetic flux density is effectively lowered while reducing the height of the transformer 20. In an example, the width d may be 5 mm, 6 mm, 8 mm, 9 mm, 10 mm, 11 mm, 12 mm, or other values ranging from 5 mm to 12 mm.

The formula m=(L/k−1)*d may be used to limit the value ranges of the length L of the first magnetic column 2111, the width d of the first magnetic column 2111, and the distance m in the magnetic core, to ensure the realization of the miniaturization of the household appliance without increasing the volume and cost of the transformer 20.

In an embodiment, the length L of the first magnetic column 2111 of the magnetic core 211 may be 20 mm, the width d of the first magnetic column 2111 may be 8 mm, and the distance m between the upper edge of the first magnetic column 2111 and the upper edge of the connection portion 2112 may be 10 mm. According to the formula m=(L/k−1)*d, it can be calculated that k is 8.9. In an embodiment, k may range from 5 to 20.

In some embodiments, a ratio of a length L of the first magnetic column 2111 to a width d of the first magnetic column 2111 ranges from 2 to 40.

In this way, through the ratio L/d of the length L of the first magnetic column 2111 to the width d of the first magnetic column 2111, it is ensured that the width d of the first magnetic column 2111 is within a small range, effectively lowering the maximum saturation magnetic flux density and improving the safety performance of the transformer 20.

In an exemplary embodiment of the present disclosure, the ratio L/d of the length L of the first magnetic column 2111 to the width d of the first magnetic column 2111 is selected to range from 2 to 40. In this way, it is ensured that the width d of the first magnetic column 2111 is within a small range to effectively lower the maximum saturation magnetic flux density.

In detail, theoretical alternating magnetic flux may generate the induced current on the cross-sectional area of conductor of the magnetic core 211. According to Lenz's law, the magnetic field generated by the induced current always opposes a change in the magnetic flux that causes the induced current, making the magnetic flux tend to the surface of the magnetic core 211, resulting in a reduction in the effective cross-sectional area of the magnetic core 211. This phenomenon is also known as the skin effect of the magnetic core.

In addition, the power magnetic core 211 has the hysteresis characteristic. For the part of the magnetic core 211 having a cross-section with a large magnetic flux density, its corresponding magnetic permeability decreases. That is, when the magnetic core 211 is excited by a predetermined current, the inductance value per winding decreases, and the anti-saturation capability of the magnetic core 211 decreases.

In an embodiment, when the cross-sectional area of the magnetic core 211 is kept the same, the skin effect of the magnetic core 211 may be reduced by reducing the width d of the flat cross-section of the magnetic core, which can effectively lower the maximum saturation magnetic flux density.

In an embodiment, the ratio L/d of the length L of the first magnetic column 2111 to the width d of the first magnetic column 2111 is selected to range from 2 to 40, i.e., 2≤L/d≤40. In an example, the ratio L/d may be 2, 7, 16, 23, 27, 34, 40, or other values ranging from 2 to 40.

Referring to FIG. 8 and FIG. 9, in some embodiments, the bobbin 220 includes a second baffle 224. The first groove 222 is separated from the second groove 223 by the second baffle 224, and a thickness g of the second baffle 224 ranges from 3.5 mm to 5 mm.

In this way, on the one hand, the first coil 230 is separated from the second coil 240 by the second baffle 224 to reduce the safety hazard. On the other hand, the bobbin 220 can adjust the leakage inductance and the coupling coefficient of the transformer 20 by adjusting the thickness g of the second baffle 224.

In an exemplary embodiment of the present disclosure, the second baffle 224 is disposed between the first groove 222 and the second groove 223 at the outer side of the hole wall of the insertion hole 221. The first coil 230 is separated from the second coil 240 by the second baffle 224 to prevent the first coil 230 and the second coil 240 from being entangled with each other, reducing the safety hazard.

In an embodiment, the second baffle 224 may be made of an insulating material to improve the inflaming retarding performance of the bobbin 220.

In an embodiment, the thickness g of the second baffle 224 is selected to range from 3.5 mm to 5 mm. The bobbin 220 may adjust the leakage inductance and coupling coefficient of the transformer 20 by adjusting the thickness g of the second baffle 224. In detail, the thickness g of the second baffle 224 is selected to range from 3.5 mm to 5 mm. As the thickness g of the second baffle 224 increases, the leakage inductance of the transformer 20 increases, and the coupling coefficient between the first coil 230 and the second coil 240 decreases. As the thickness g of the second baffle 224 decreases, the leakage inductance of the transformer 20 decreases, and the coupling coefficient between the first coil 230 and the second coil 240 increases.

The thickness g is selected to range from 3.5 mm to 5 mm, i.e., 3.5 mm≤g≤5 mm. In an example, the thickness g may be 3.5 mm, 3.7 mm, 3.8 mm, 4.0 mm, 4.3 mm, 4.6 mm, 5 mm, or other values ranging from 3.5 mm to 5 mm.

The embodiments of the present disclosure also provide a household appliance. The household appliance includes the transformer 20 according to any one of the above embodiments.

In the above household appliance, the first coil 230 is wound on the first winding surface 2221, and the second coil 240 is wound on the second winding surface 2231. The height difference exists between the first winding surface 2221 and the second winding surface 2231 in the radial direction of the insertion hole 221. As a result, the first coil 230 and the second coil 240 are wound in a staggered manner. In this way, the coupling coefficient can be reduced, and the hard switching characteristic of the IGBT at low power can be reduced, thus enabling adaptation to low-power application.

It should be noted that the above explanations of the embodiments and beneficial effects of the transformer 20 are also applicable to the household appliance of the embodiments of the present disclosure, and details thereof are omitted herein for the avoidance of redundancy.

The household appliance includes, but is not limited to, a microwave oven, a combination steam and bake oven, an air conditioner, or a dishwasher. The household appliance is widely used in food cooking, tableware cleaning, and the like.

In the description of this specification, descriptions with reference to the terms “an embodiment”, “some embodiments”, “schematic embodiments”, “examples”, “specific examples”, or “some examples”, etc. mean that specific features, structure, materials, or characteristics described in conjunction with the embodiment or example are included in at least an embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although the embodiments of the present disclosure according to the present disclosure have been shown and described, it would be appreciated by those skilled in the art that the above embodiments are illustrative and cannot be construed to limitation on the present disclosure, and changes, alternatives, modifications, and variations can be made in the above embodiments without departing from scope of the present disclosure.

1-14. (canceled)

15. A transformer, comprising:
a magnetic core structure comprising two magnetic cores, each of the two magnetic cores having a first magnetic column of a flat shape, wherein a length direction of the first magnetic column is along a length direction of the magnetic core;
a bobbin having an insertion hole that fits a shape of the first magnetic column, wherein a hole wall of the insertion hole has a first groove and a second groove that are formed on an outer side of the hole wall and spaced apart from each other, the first magnetic column being at least partially located in the insertion hole, and two first magnetic columns of the two magnetic cores being spaced apart from each other and arranged opposite to each other;
a first coil wound around the outer side of the hole wall of the insertion hole and located in the first groove; and
a second coil wound around the outer side of the hole wall of the insertion hole and located in the second groove.

16. The transformer according to claim 15, wherein:
the first coil is a primary coil, and the second coil is a secondary coil; and
the two first magnetic columns are spaced apart from each other and arranged opposite to each other to form an air gap, the air gap being located adjacent to the first coil.

17. The transformer according to claim 16, wherein a width of the air gap ranges from 1.5 mm to 3.2 mm.

18. The transformer according to claim 15, wherein:
a bottom surface of the first groove serves as a first winding surface; and
a bottom surface of the second groove serves as a second winding surface,
wherein a height difference exists between the first winding surface and the second winding surface in a radial direction of the insertion hole.

19. A transformer, comprising:
a magnetic core structure comprising two magnetic cores, each of the two magnetic cores having a first magnetic column;
a bobbin having an insertion hole that fits a shape of the first magnetic column, wherein a hole wall of the insertion hole has a first groove and a second groove that are formed on an outer side of the hole wall and spaced apart from each other, the first magnetic column being at least partially located in the insertion hole, and two first magnetic columns of the two magnetic cores being spaced apart from each other and arranged opposite to each other, wherein a bottom surface of the first groove serves as a first winding surface, and wherein a bottom surface of the second groove serves as a second winding surface, a height difference existing between the first winding surface and the second winding surface in a radial direction of the insertion hole;
a first coil wound on the first winding surface and located in the first groove; and
a second coil wound on the second winding surface and located in the second groove.

20. The transformer according to claim 19, wherein the height difference ranges from 0.5 mm to 4 mm.

21. The transformer according to claim 19, wherein the height difference exists over a circumference of the insertion hole by 360°.

22. The transformer according to claim 19, wherein:
the insertion hole is of a flat shape, a length direction of a radial cross-section of the insertion hole being perpendicular to a height direction of the transformer; and
the height difference comprises a first height difference in the length direction of the radial cross-section of the insertion hole and a second height difference in a width direction of the radial cross-section of the insertion hole, the first height difference being equal to the second height difference.

23. The transformer according to claim 15, wherein:
the first magnetic column is of a flat shape fitting a shape of the insertion hole; and
a length direction of the first magnetic column is along a length direction of the magnetic core.

24. The transformer according to claim 15, wherein each of the two magnetic cores further comprises a connection portion and a second magnetic column, the first magnetic column and the second magnetic column being connected to each other by the connection portion, the second magnetic column being located outside the insertion hole, and two second magnetic columns of the two magnetic cores being spaced apart from each other and arranged opposite to each other outside the first groove.

25. The transformer according to claim 24, wherein in a height direction of the transformer, a distance between an upper edge of the first magnetic column and an upper edge of the connection portion is m, where m=(L/k−1)*d, wherein:
k ranges from 5 to 20;
L represents a length of the first magnetic column; and
d represents a width of the first magnetic column.

26. The transformer according to claim 15, wherein a ratio of a length L of the first magnetic column to a width d of the first magnetic column ranges from 2 to 40.

27. The transformer according to claim 25, wherein the width d of the first magnetic column ranges from 5 mm to 12 mm.

28. The transformer according to claim 15, wherein the bobbin comprises a second baffle, the first groove being separated from the second groove by the second baffle, and a thickness g of the second baffle ranging from 3.5 mm to 5 mm.

29. (canceled)

30. A household appliance, comprising a transformer, wherein the transformer comprises:
a magnetic core structure comprising two magnetic cores, each of the two magnetic cores having a first magnetic column of a flat shape, wherein a length direction of the first magnetic column is along a length direction of the magnetic core;
a bobbin having an insertion hole that fits a shape of the first magnetic column, wherein a hole wall of the insertion hole has a first groove and a second groove that are formed on an outer side of the hole wall and spaced apart from each other, the first magnetic column being at least partially located in the insertion hole, and two first magnetic columns of the two magnetic cores being spaced apart from each other and arranged opposite to each other;
a first coil wound around the outer side of the hole wall of the insertion hole and located in the first groove; and
a second coil wound around the outer side of the hole wall of the insertion hole and located in the second groove.

31. The transformer according to claim 19, wherein:
the first magnetic column is of a flat shape fitting a shape of the insertion hole; and
a length direction of the first magnetic column is along a length direction of the magnetic core.

32. The transformer according to claim 19, wherein each of the two magnetic cores further comprises a connection portion and a second magnetic column, the first magnetic column and the second magnetic column being connected to each other by the connection portion, the second magnetic column being located outside the insertion hole, and two second magnetic columns of the two magnetic cores being spaced apart from each other and arranged opposite to each other outside the first groove.

33. The transformer according to claim 32, wherein in a height direction of the transformer, a distance between an upper edge of the first magnetic column and an upper edge of the connection portion is m, where m=(L/k−1)*d, wherein:
k ranges from 5 to 20;
L represents a length of the first magnetic column; and
d represents a width of the first magnetic column.

34. The transformer according to claim 19, wherein a ratio of a length L of the first magnetic column to a width d of the first magnetic column ranges from 2 to 40.

35. The transformer according to claim 19, wherein the bobbin comprises a second baffle, the first groove being separated from the second groove by the second baffle, and a thickness g of the second baffle ranging from 3.5 mm to 5 mm.
